(19) United States
(12) Patent Application Publication
(10) Pub. No.: US 2013/0273349 A1
(43) Pub. Date: Oct. 17, 2013

(54) HEAT-EMITTING GRAPHITE MATERIAL COMPRISING AMORPHOUS CARBON PARTICLES AND A PRODUCTION METHOD THEREFOR

(71) Applicants: Suk-Hong CHOI, Seoul (KR); Sang-Hee PARK, Bucheon-si (KR)

(72) Inventors: Suk-Hong CHOI, Seoul (KR); Sang-Hee PARK, Bucheon-si (KR)

(21) Appl. No.: 13/760,500

(22) Filed: Feb. 6, 2013

Related U.S. Application Data
(62) Division of application No. 13/392,869, filed on Feb. 27, 2012, now abandoned.

(30) Foreign Application Priority Data
Sep. 1, 2009 (KR) 10-2009-0082096

(51) Int. Cl. C09K 5/14

(52) U.S. Cl. CPC C09K 5/14
USPC 428/323; 428/408

(57) ABSTRACT

This invention relates to a heat control system for dissipating heat generated from for example electronic equipment, and more specifically to an effective heat-emitting material which can drastically improve not only heat diffusion in the planar direction but also heat conductivity in the perpendicular direction by filling the pores of exfoliated graphite sheets with amorphous carbon particles, and to a method of manufacturing the same. The amorphous carbon particles are thermally isotropic, and have a structure composed of microcrystals of graphite and diamond and preferably have a size of 10-110 nm.

### CROSS REFERENCE TO RELATED APPLICATIONS

This application is a divisional application of U.S. patent application Ser. No. 13/392,869, filed Feb. 27, 2012 (now pending), which is a national entry of International Application No. PCT/KR2009/007462, filed Dec. 14, 2009, which claims priority to Korean Patent Application No. 10-2009-0082096, filed Sep. 1, 2009, the entire contents of which are incorporated herein by reference.

### TECHNICAL FIELD

The present invention relates to a graphite-based heat-emitting material suitable for use in manufacturing heat-emitting sheets, heat-emitting rolls, heat-emitting pads, heat-emitting plates, etc. Particularly the present invention relates to a material for emitting heat generated from integrated circuits of a variety of electronic products, light sources of LEDs and the like. More particularly the present invention relates to a thermal heat-emitting material which may prevent a decrease in the reliability and durability of electronic equipment including notebook computers, portable PCs, typical PCs, portable terminals, and display panel LCD related products because of an excessive temperature increase.

### BACKGROUND ART

Recently it is being required that not only LCD TV, PDP TV and LED TV but also any electronic equipment, LED electronic illuminators, etc. have high efficiency and high functionality, and thereby a large amount of heat is generated over a small area. Specifically, as the social demand for light, slim, short and small parts having high efficiency and high functionality is increasing, heat generated from sets, parts, modules and so on of electronic products which are designed is regarded as an important issue when developing the products.

Exfoliated natural graphite has been used to date in the form of a gasket or a sheet using compression molding.

However, compressed graphite is anisotropic. Depending on the degree of compression, the heat conductivity of compressed graphite is 150 W/mk or more in a planar direction but is 3˜7 W/mk or less in a perpendicular direction, and heat diffusion to the edge thereof to dissipate heat has been adopted. Furthermore, a thermal heat-emitting system using aluminum, copper, etc., has been conventionally used, but the generation of hot spots on a heat-emitting plate cannot be avoided because of thermal isotropy of the metal material.

The air layer that exists in a conventional graphite sheet has a heat conductivity of about 0.025 W/mk, which undesirably causes the heat conductivity to decrease in the planar and perpendicular directions. To improve heat transfer in the perpendicular direction, there have been proposed methods comprising impregnation of graphite with a resin, compression molding and then thermal decomposition in an inert gas. However, such methods are problematic because of complicated processes, the generation of toxic gases, and excessive manufacturing cost, undesirably negating the economic benefit.

Thus, there is a continuous need for a heat-emitting material which has very superior heat conductivity, generates no hot spots and is profitable.

### DISCLOSURE

### Technical Problem

Accordingly, an object of the present invention is to provide a heat-emitting material having high heat conductivity.

More specifically, an object of the present invention is to provide a heat-emitting material which may increase heat conductivity and heat diffusivity in a planar direction in a surface parallel to a plane that comes into contact with a heat source and as well may drastically increase the amount of heat dissipated in a direction perpendicular thereto, and also to provide a method of manufacturing the same. This heat-emitting material is capable of greatly enhancing performance and durability of for example electronic products that it is applied to.

### Technical Solution

In order to accomplish the above objects, the present invention provides a heat-emitting material which is configured such that pores included upon compression molding of expanded natural graphite are filled with amorphous carbon particles.

To date, graphite obtained by subjecting rosette graphite to grinding to a predetermined size, oxidation, intercalation to about 80˜150° C., washing and drying has been used. The intercalated graphite begins to expand at 160° C. or higher, and particularly upon expansion in a furnace at 600˜1,000° C., graphite particles expand 80˜1000 times or more in a C-axis direction, namely, in a direction perpendicular to the crystalline plane of graphite particles.

In the present specification, the graphite powder is graphite powder having a particle size of 30˜80 mesh.

Typically a graphite sheet is prepared by subjecting graphite having an expansion volume of about 180˜250 ml/g to roller compression molding at a compression rate of 30% or more.

After roller compression molding, the density of the sheet may be 0.8˜1.25 g/cm³ and may be adjusted by pressure applied to the expanded graphite particles and rollers, and the sheet may have a thickness of 0.1˜6.0 mm.

When the compression rate of the expanded graphite is increased by roller compression molding (when the density is increased), thermal anisotropy is increased thus improving heat diffusion performance. In this case, however, the heat diffusivity and conductivity of electron parts or the like in the perpendicular direction are low, and heat emission loads on the edge may increase. This means that heat emission to the back surface of a sheet having a large area becomes more difficult. Specifically, as the density of the graphite sheet increases, the action thereof as a heat diffuser becomes superior, but heat emission in the perpendicular direction is merely limited to heat emission by air convection, thus decreasing the heat conductivity in the perpendicular direction, so that heat emission to the back surface cannot avoid being lowered.

Pores are present in the expanded compressed graphite, and air existing in such pores has a heat conductivity of 0.025 W/mk, which undesirably decreases the heat conductivity in the perpendicular and planar directions. As shown in the electron microscope image, the pores which are long in the planar direction and short in the perpendicular direction are observed. When the pores of the sheet are minimized, the heat conductivity in the planar direction may increase but the heat conductivity of the back surface may decrease.

Thus, the present invention is based on the astonishing finding that, in the case where amorphous carbon particles are used to fill the pores of such a graphite sheet, cooling performance may be improved by air convection in the perpendicular direction and heat conductivity may increase in the planar direction thus achieving high thermal anisotropy and drastically increasing heat emission in the perpendicular direction.

The theoretical density of typical graphite is about 2.28 g/cm³, and the density of the sheet manufactured from such graphite using conventional roller compression is 0.8˜1.25 g/cm³, so that pores corresponding to about 45˜65% of the theoretical density of typical graphite remain in the graphite sheet.

According to the present invention, the amorphous carbon particles may increase the density of the molded body in the compression molding process to thus improve heat diffusion and heat conductivity. The amorphous carbon particles may decrease the presence of the pores corresponding to about 45˜65% of the above theoretical density to 15˜55% and may control heat conductivity depending on the density.

To emit heat in the perpendicular direction of the graphite sheet, it is possible to carry out mixing of a thermal isotropic material, that is, metal (Al, Cu, etc.) particles or particle size blending of graphite particles. However, the mixing of metal particles is problematic because it is difficult to reduce the size of particles, and is unprofitable in terms of price. Furthermore, the weight of the sheet may comparatively increase. On the other hand, the particle size blending of graphite particles is problematic because it is difficult to grind expanded graphite and to simultaneously increase heat conductivity in both the perpendicular direction and the planar direction due to the orientation of graphite particles during the compression molding that takes place after particle size blending, and it is also difficult to control the heat conductivity.

According to the present invention, the amorphous carbon particles charged into the pores of the expanded graphite may be manufactured from one or more selected from the group consisting of pitch, coke, natural gas and tar. For example, they may be manufactured by collecting soot obtained from the incomplete combustion of natural gas, tar, etc., or by thermally decomposing such materials.

Amorphous carbon does not have an obvious crystalline structure as do the isotopes of carbon of graphite or diamond. Strictly speaking, amorphous carbon is not completely amorphous and comprises microcrystals of graphite and diamond.

The structure of an amorphous solid is controlled via bonding. An atomic bond includes a directional bond and a non-directional bond. Directional bonds include a covalent bond, and non-directional bonds include an ionic bond, a bond by Van der Waals force, etc. The atom arrays formed via such bonds are well known to be characteristic in their own ways. The array ordering apparently appears under a crystalline condition and may also be shown as a non-crystalline solid.

The amorphous carbon particles may manifest ordering depending on such a directional bond. The carbon atom has one 2S orbital and three 2P orbitals. Upon bonding, the above four orbitals are mixed to form an SP³ hybrid orbital corresponding to a diamond structure, and the three orbitals are formed into an SP² hybrid orbital corresponding to a graphite structure.

FIG. 1 shows the X-ray diffraction of the amorphous carbon particles wherein the diffraction peak of the (002) plane of 2θ 26° graphite and the diffraction peak of the diamond plane near 2θ 44° are seen. Thus, with reference to the above drawing, the structure of the amorphous carbon particles is considered to be a combination of two kinds of domains as shown in FIG. 3.

Specifically, as shown in FIG. 3, the domain D includes a diamond structure of carbon atoms and the domain G has a graphite structure. Each has a size of tens of A° and forms a completely random array. As seen in FIG. 3, the amorphous carbon particles have crystalline structures of respective atomic arrays and are thermally isotropic and the heat conductivity thereof may exhibit the inherent properties of diamond and graphite.

Diamond has a heat conductivity superior to copper and is isotropic, and graphite shows anisotropic heat conductivity, which is known in the literature to be about 230 W/mk or more in the planar direction and about 5 W/mk or less in the axial direction and the perpendicular direction. The amorphous carbon particles according to the present invention are a structurally random agglomerate which is amorphous, that is, a thermally isotropic graphite-diamond agglomerate.

The isotropic molded body of graphite has a heat conductivity of 80 W/mk at a density of 1.75 g/cm³, and 160 W/mk at a density of 1.85 g/cm³, and the heat conductivity of the isotropic graphite is inferior to that of the anisotropic graphite sheet in the planar direction but is regarded as good.

Such amorphous carbon particles preferably have a particle size of 10˜110 nm. When such amorphous carbon particles are used, heat emission effects may be maximized, and upon compression molding of graphite, the above particles may be easily loaded between graphite particles.

In the heat-emitting material according to the present invention, the amount of the amorphous carbon particles may be 5˜30 wt % based on the total weight of the expanded graphite and the amorphous carbon particles. When the amount thereof falls in the range of 5˜30 wt %, mass production may be achieved, and performance may be improved, that is, heat conductivity in the planar direction and the perpendicular direction is drastically increased. If the amount of the amorphous carbon particles is less than 5%, insignificant effects may be obtained. In contrast, if the amount thereof exceeds 30%, stable productivity and reliability may not be obtained via the blending of amorphous carbon particles.

Thus, in order to accomplish the above object, the present invention provides a heat-emitting solution for diffusing heat generated from the upper surface of various integrated circuits of circuit boards of electronic products, light sources of display devices, etc., via direct/indirect contact with a panel and an installation media such as a case.

This solution is a method of manufacturing the graphite sheet wherein exfoliated graphite, which has been expanded 400˜1000 times by intercalating graphite, is mixed with amorphous carbon particles, and the resulting mixture is subjected to roller compression molding thus obtaining high performance as in a conventional anisotropic sheet and remarkably increasing isotropic thermal properties 4˜5 times or more in the perpendicular direction.

Specifically, the amorphous carbon particles may be mixed in the course of expanding graphite or may be mixed upon compression molding using a calendar process, thereby manufacturing a sheet or a roll, or a three-dimensional shape or a heat-emitting pad, a heat-emitting plate, a heat-emitting film, etc.

More specifically, the present invention provides a method of manufacturing a heat-emitting material, comprising (S1) mixing expanded graphite with 5˜30 wt % of amorphous carbon particles based on the total weight of the expanded graphite and the amorphous carbon particles; and (S2) subjecting the mixture of (S1) to compression molding thus manufacturing a heat-emitting sheet.

For example, (S2) is performed by passing the mixture through for example five rollers under conditions of a compression rate of 30% or more, a molding pressure of 400 kg/cm³˜1.5 ton/cm³, a temperature of about room temperature, and a period of time of about 1˜3 min to compress it, so that the density and the thickness of a product may be adjusted.

The heat diffusion and heat conductivity provided in the planar direction by the heat-emitting material used in the present invention may be much greater than the heat conductivity in the perpendicular direction but the perpendicular heat conduction effects which are conventionally considered to be problematic may be further improved thus achieving a much better thermal solution. Depending on the needs of users, one or more adhesive or polymer films (PET, PE, PI, etc.) may be attached to the surface of the heat-emitting material according to the present invention, or chemical coating (UV, PAN coating, etc.) may be applied, thereby facilitating the production, assembly or use of the heat-emitting material according to the present invention. The heat-emitting material according to the present invention may be applied to parts and panels, cases or the like of electronic products, and may be compressed with a non-conductive or conductive adhesive depending on the end uses.

Attaching the polymer film (PET, PE, PI, etc.) to the surface of the heat-emitting material according to the present invention or using the chemical coating (UV, PAN) material in an amount of 4 wt % or more, preferably 4˜30 wt % and more preferably up to 50 wt % may be carried out. As such, impregnation may be conducted after oxidation or without performing oxidation, and impregnation without oxidation may be utilized.

The adhesive may be a double-sided tape having heat resistance at 80˜180° C.

Also the heat-emitting material according to the present invention may be subjected to adhesion treatment using appropriate means typically known in the art and thereby may be used as a conductive adhesive and a heat-emitting tape, which enables the various applications of the heat-emitting material according to the present invention.

### Advantageous Effects

With the recent trend to develop and produce electronic products which are very slim, light and thin, the heat-emitting material according to the present invention can effectively control the heat generated from electronic equipment composed of electronic circuits. The heat diffusion and heat-emitting material according to the present invention can be applied to a variety of end uses, and can greatly increase heat emission efficiency by four times or more compared to when using conventional heat-emitting methods. Also the heat-emitting material according to the present invention is profitable and can reduce the weight of the applied product sets thus positively affecting the slimness of electronic equipment.

### DESCRIPTION OF DRAWINGS

The above and other objects, features and advantages of the present invention will be more clearly understood from the following detailed description taken in conjunction with the accompanying drawings, in which:

FIG. 1 shows X-ray diffraction of amorphous carbon particles used in the present invention, wherein the diffraction peak of the (002) plane of graphite near 2θ 26° and the diffraction peak by the value d of the diamond plane near 2θ 44° are observed;

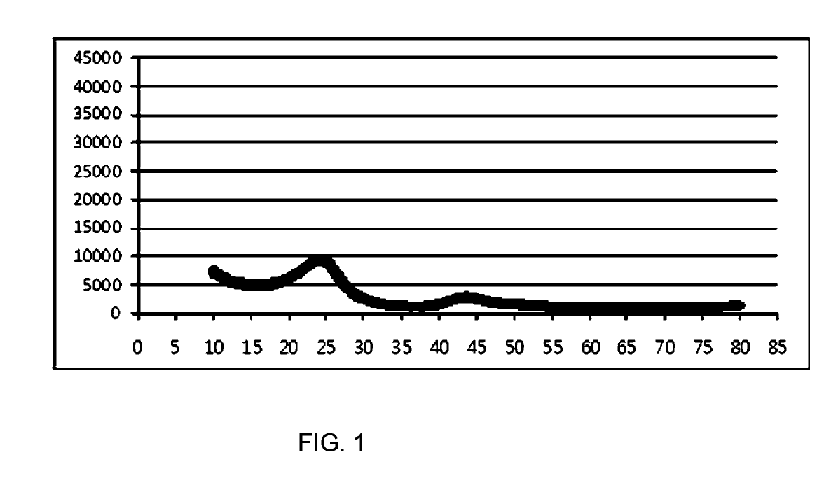

FIG. 2 is an SEM image showing graphite and amorphous carbon particles which are mixed together, according to an embodiment of the present invention; and

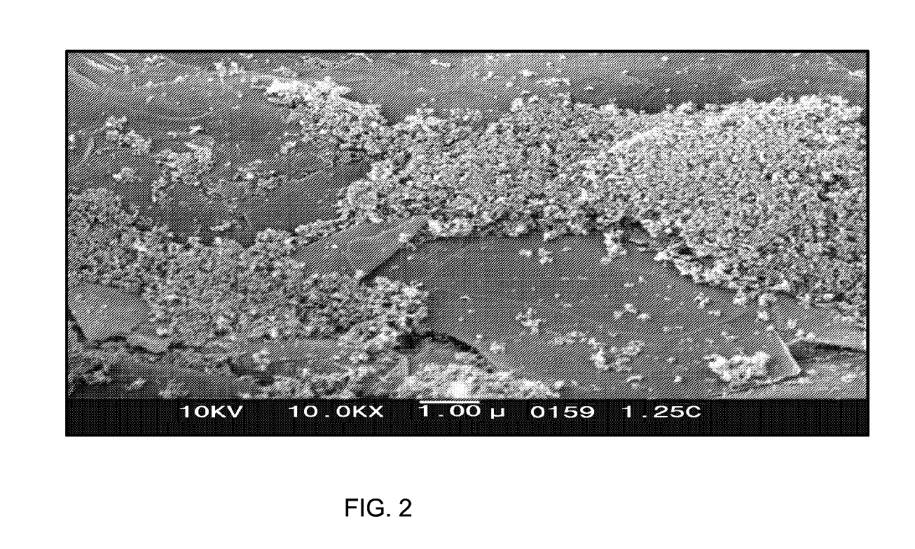

FIG. 3 shows a structure of the amorphous carbon particles.

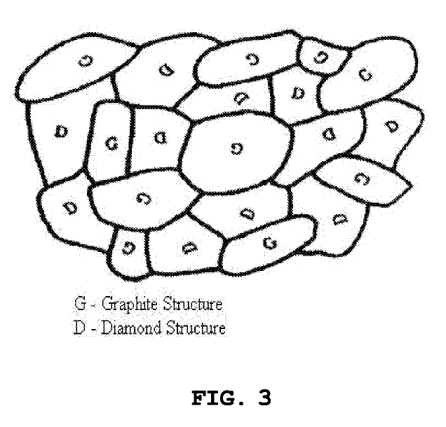

### MODE FOR INVENTION

The following examples which are set forth to illustrate but are not to be construed as limiting the present invention, may provide a better understanding of the present invention and may be appropriately modified or varied yet remain within the scope of the present invention, as will be apparent to those skilled in the art.

### EXAMPLE 1

Graphite used in the present invention is expanded graphite having a high expansion volume of 380 ml/g to prevent thermal properties from deteriorating as would happen were non-expanded graphite to be used, and a predetermined amount of 60 nm amorphous carbon particles were mixed therewith, after which the resulting mixture was subjected to roller compression molding at a compression rate of 30% or more, thus manufacturing a sheet having a density of 1˜2 g/cm³.

As shown in Table 1 below, expanded graphite was mixed with amorphous carbon particles. Respective samples were manufactured into sheets under conditions of a thickness of 1 mm, a compression rate of 30% or more, and a pressure of 500˜700 kg/cm².

TABLE 1

| Sample | Graphite | Amorphous Carbon |
|---|---|---|
| No. | (wt %) | Particles (wt %) |
| 1 | 100 | 0 |
| 2 | 95 | 5 |
| 3 | 90 | 10 |
| 4 | 85 | 15 |
| 5 | 80 | 20 |
| 6 | 70 | 30 |

The heat conductivity of the manufactured samples was measured. The results are shown in Table 2 below.

TABLE 2

| | Amount of | | | | | |
|---|---|---|---|---|---|---|
| | Mixed | | Planar | | Perpendicular | |
| | Amorphous | | Heat | Improvement | Heat | Improvement |
| Sample | Carbon | Density | conductivity | in | conductivity | in |
| No. | Particles | g/cm³ | W/mk | Performance | W/mk | Performance |
| 1 | 0 | 1.0 | 480 | Standard | 5.2 | 100% |
| | | | | | | Standard |
| 2 | 5% | 1.58 | 512 | 6.7% | 15.8 | 304% |
| 3 | 10% | 1.61 | 532 | 10.8% | 20.5 | 394.2% |
| 4 | 15% | 1.67 | 548 | 14.2% | 25.7 | 494.2% |
| 5 | 20% | 1.68 | 552 | 15% | 26.3 | 505.7% |
| 6 | 30% | 1.69 | 561 | 16.9% | 26.5 | 509.6% |

As is apparent from Table 2, as the amorphous carbon particles were contained, heat conductivity was remarkably improved.

1. A graphite sheet, comprising:
an compressed graphite layer molded by exfoliated graphite particles;
amorphous carbon particles filled with in pores of the compressed graphite;
a film attached to at least one surface of the compressed graphite layer; and
an adhesive coating at least one surface of the film, wherein an amount of the amorphous carbon particles is 18 30 wt % based on a total weight of the compressed graphite and the amorphous carbon particles, wherein the graphite layer has a density of 1.0˜2.0 g/cm³, and
wherein the graphite layer has a heat conductivity of 500˜600 W/mK in a planar direction and of 15˜30 W/mK in a perpendicular direction.

2. The graphite sheet of claim 1, wherein the amorphous carbon particles are manufactured from one or more selected from the group consisting of pitch, coke, natural gas and tar.

3. The graphite sheet of claim 1, wherein a size of the amorphous carbon particles is 10˜110 nm.

4. The graphite sheet of claim 1, wherein the film is at least one selected from the group consisting of PET, PE and PI.

5. The graphite sheet of claim 1, wherein the exfoliated graphite is expanded 400˜1000 times.

6. The graphite sheet of claim 1, wherein a compression rate of the compressed graphite is 30% or more.
